(19) United States
(12) Patent Application Publication
(10) Pub. No.: US 2002/0041437 A1
(43) Pub. Date: Apr. 11, 2002

(54) Ultraviolet radiation blocking coating system

(76) Inventor: Lester Cornelius, Oyster Bay, NY (US)

Correspondence Address: CHARLES E. TEMKO, 22 MARION ROAD, WESTPORT, CT, 06880, US

(21) Appl. No.: 09/849,884

(22) Filed: May 4, 2001

Related U.S. Application Data
(60) Provisional application No. 60/220,173, filed on Jul. 24, 2000.

(51) Int. Cl. F21V 9/06; G02B 5/22

(52) U.S. Cl. 359/361; 359/359; 359/890; 252/588; 252/589; 428/451

(57) ABSTRACT

A two-layer coating system blocks ultraviolet radiation up to and including 400 nanometers, the upper end of ultra violet light. An inner layer blocks radiation from about 375 nanometers to 400 nanometers. An outer layer absorbs radiation up to 375 nanometers.

### RELATED APPLICATION

Reference is made to my co-pending provisional application letters patent, Ser. No. 60/220,173, filed Jul. 24, 2000, to which a claim of priority is made.

### BACKGROUND OF THE INVENTION

Ultraviolet radiation is composed of three ranges, namely: UVA, which is from 320 to 400 nanometers, UVB which is from 280 to 320 nanometers, and UVC which is from 100 to 280 nanometers. UVA and UVB are attenuated by the atmosphere, but it still reaches the earth's surface. UVC is usually blocked by the ozone in the atmosphere. Man-made lighting sources also produce ultraviolet radiation. Most fluorescent lighting has a high output in the UVA range. UVB causes more damage than UVA, but all ultraviolet radiation will cause degradation to materials.

Ultraviolet rays from the sun, or from man-made sources, degrade many materials by breaking their molecular bonds. Dyes and inks fade from ultraviolet, plastics lose their properties, paints chalk and fade, and many other items are damaged. Strategies to combat ultraviolet degradation include the use of materials that absorb ultraviolet radiation and convert it to heat energy. Most absorbers have an ultraviolet cutoff of 365 nanometers. A few have higher cutoffs, up to 384 nanometers with little to no yellowing. The phenomenon of producing a yellow cast when absorbers are used to block all of the ultraviolet radiation is due to the gradual slope of the absorption curve of the absorbing material. This slope, when the cutoff is extended to 400 nanometers, causes absorption of violet and blue light. The absence of blue light is perceived as yellow, and it is for this reason that most absorbers, especially in clear overcoatings, are not used to block all of the ultraviolet radiation up to 400 nm.

The optical density of a filter, an absorber, or a coating, to a range of radiation, is directly related to the concentration and thickness of the layer. The thinner the layer, the higher the concentration of absorber is required. Very thin coating layers, below 10 microns cannot contain sufficient levels of absorption without a significant loss in the properties of the coating material. As an example, a 4 micron clear coating might require thirty percent, by weight, of an absorber to have complete absorption up to the cutoff wavelength of the absorber. Some common classes of ultraviolet absorbers are benzophenones and benzotriazoles.

A coating layer that is effective in blocking ultraviolet and is thin has the additional advantage of lower material cost and a higher degree of possible flexibility. A coating with a low concentration of absorber, so that the physical properties of the coating layer are not diminished, as well as the lower cost of using less absorber, that blocks all ultraviolet up to 400 nm, and does not have a significant effect on blue light absorption would be a significant improvement in the effort to stop ultraviolet damage to materials.

### SUMMARY OF THE INVENTION

The disclosed coating system blocks ultraviolet radiation up to and including 400 nanometers, the upper end of ultra violet light. Preventing ultraviolet (uv) radiation from reaching materials and surfaces greatly improves weatherability and resistance to physical degradation from the effects of uv radiation on chemical bonds. There currently exist many types of ultra violet inhibitors which are meant to be included in materials to improve their resistance to uv radiation. The damage from uv radiation is greater as the wavelengths of uv become shorter. However, considerable damage still occurs from the longer wavelengths of uv radiation. It is desirable to block the uv radiation and not have yellowing effect. The disclosed coating system remains water white.

### DETAILED DESCRIPTION OF THE DISCLOSED EMBODIMENTS

In accordance with the invention, the disclosed coating system is a two-layered system using a typical ultraviolet asorber in its inner layer (called the blocking layer), furthest away from the source of ultraviolet exposure, with a fluorescent material which reflects ultraviolet radiation back as blue light. The ultraviolet absorber in the inner layer is used in sufficient concentration to have an ultraviolet cutoff which can be extended with the fluorescent material. There are natural fluorescent materials such as calcite, willemite, esperite, fluorite, and diamonds. There are also man-made fluorescent materials used to make materials look whiter by reflecting the longewave ultraviolet radiation as blue ight. These are called optical brighteners. Typical optaical brighteners are disuphonates, tetrasulphonates, and hexasulphonates. These are water soluble optical brighteners. An example of a solvent soluble optical brightener is Uvitex OB from Ciba-Geigy Corp.

Such optical brighteners are typically used in textiles at very low concentrations of less than one percent by weight. Their purpose is to reduce the yellowness of a material, dye, plastic, etc. The present invention provides the desired protection by combining an optical brightener with an ultraviolet radiation absorber which raises the cutoff wavelength and increases blue light, rather than absorbing blue light as a longer wavelength cutoff ultraviolet absorber would normally do.

This barrier requires high levels of optical brightener to convert the longer wavelength ultraviolet radiation into blue light and do this effectly enough to block the transmission from the outer layer to the inner layer due to the total conversion of longer wavelength ultraviolet to blue light. The high level of optical brightener causes a significant fluorescent effect upon exposure to ultraviolet radiation, where this layer will glow with blue light.

The surface of the inner or blocking layer also has a significant quantity of fluorescent material which is not protected in depth by the included ultraviolet absorber. This is the primary reason the second or outer coating layer is effective in reducing fluorescence and why it is necessary. The fluorescent material in the inner layer that lies in the matrix of resin and ultraviolet absorber is then protected from excessive fluorescent excitation. Another technique is to use an alkaline material in the outer coating to decompose the surface of the optical brightener of the blocking layer. Still another technique to reduce surface fluorescence is to use an optical brightener quencher such as OBA Quencher from Kalamazoo Paper Chemicals Corp.

While a single blocking layer can be used for protection against ultraviolet, the fluorescent blue glow is generally undesirable. In order to significantly reduce this fluorescence, it is necessary to reduce the amount of ultraviolet that reaches this layer in the peak wavelengths for fluorescence. This is done by applying an overcoating to the blocking layer which contains some level of ultraviolet absorber that reduces the ultraviolet transmission of the wavelengths that cause fluorescence. It is then this combined effect and balance which completely blocks ultraviolet radiation without yellowing.

The outer coating can provide other properties such as chemical resistance, scratch resistance, slip, or friction. The outer coating material can be any resin system with an ultraviolet inhibitor, but it is preferably clear and relatively ultraviolet transparent. Materials that do not absorb ultraviolet on their own are relatively unaffected by exposure to it. For this reason, typical clear outer coating resins would be aliphatic urethanes, polysiloxanes, or acrylics.

Fluorescent materials have been used in many applications to “whiten” whites, or brighten colors in many products. The technique is to use the fluorescent material to increase the reflected blue light. The increase in blue light is perceived as a reduction in yellow light from the fluorescent material. It typically takes very small quantities of fluorescent material to accomplish this brightening effect.

Uv absorbers are widely available and are commonly used with the intention of blocking primarily UVB. When these uv absorbers are used to block all uv light, they increase yellow light perception due to the reduction in blue light.

Higher concentrations of fluorescent materials in a single layer coating will cause a blue fluorescent glow to the material when it is exposed to uv light. This is cosmetically objectionable. For this reason, only low concentrations are used for brightening.

Blocking uv from reaching the surface of an object is a function of film thickness and concentration. Thin films down to 3-5 microns would require very high concentrations of uv absorbers to have complete blocking power. These thin films, such as those in polysiloxane abrasion resistant coatings, would need uv absorber concentrations as high as 30 percent to accomplish an optimal absorption based on the uv absorber. At that concentration, the properties of the coating are drastically degraded.

The inside layer of the present system can be in a range of 6 microns or higher, using Uvitex OB (Ciba-Geigy), with 9-15 microns being optimum. This range is based on the maximum solubility of the uv absorber and the fluorescent material. If other uv absorbers and fluorescent materials are chosen, this film thickness range can be adjusted accordingly.

The second or outer coat, in order to maintain flexibility, must be in the 3 micron-3 mil range film thickness depending on the brittleness of the resin system. In order to maintain the properties of the outer coat at this film thickness, it is necessary to keep the uv absorber in this layer at the maximum level before degradation of the physical properties of the coating occurs.

In accordance with the invention, the disclosed system includes an outer coating which also has a uv absorber to prevent the blue glow at the inner surface of an inner layer. This blue glow will appear hazy prior to application of the outer coating.

UA absorbers that block all uv up to 400 nm tend to be significantly yellow in color. This is because of their absorption curve. The more gradual the slope of the curve the more visible blue and violet light is absorbed which is then perceived as yellow. It is desirable when blocking uv up to 400 nm to have a very steep transmission curve with a transmission cutoff at 400 nm to avoid the yellowing effect.

Degradation due to outdoor exposure also occurs from pollutants which are carried to the item via precipitation and air. These pollutants are typically oxides and various dilute acids such as acid rain. The pollutants can cause colorants to fade as the molecular bonds are broken. It is desirable to have protection against this type of chemical breakdown such as a chemically resistant barrier.

Certain items, such as printed paper, can also be damaged by precipitation such as rain and snow which, in the form of water, causes the paper to deteriorate and some print materials such as a ink to bleed. It is therefore desirable to create a barrier to precipitation for good outdoor weatherability.

There currently exist coatings and laminations which are partial uv blockers and which are transparent but have poor abrasion resistance, such as vinyl coatings and laminates. It is desirable to have good abrasion resistance in a product to be used outdoors to prevent changes in gloss levels from abrasion which might be caused by windborne debris or cleaning.

The current practice of including uv absorbers in the body of plastic items, or in overcoatings is often of limited effectiveness because it is weakened by the relationship of film thickness and concentration of uv absorber. The thicker the coating the lower the concentration of uv blocker necessary. Thin coatings are often desirable due to cost and flexibility. When a uv absorber is included in a colored molded item, the surface has the lowest concentration of uv absorber and so this surface degrades quicker than the material behind this surface. Thus, even though the colored material contains uv absorber, its relative concentration at the surface of the item is low, so the color fades at the surface. With suitable coating, the weatherability of a molded plastic item is improved in terms of physical properties except for a significant improvement in color fade, as this is a surface effect. The bulk of the material has protection in depth.

The best combination of protection against color fade is to include pigments which are resistant to uv degradation along with uv inhibitors. In the inkjet industry it is common to combine uv resistant inks with a uv inhibiting outer laminate for further protection against fading in applications where long term exposure to uv is expected.

Solvent selection requires compatibility with the resin systems and additives, leveling characteristics, and the prevention of crystallization of the additives. The following examples are illustrataive.

### EXAMPLE 1

The following example achieves a 9-10 micron film thickness. Percentages are by weight of volume solids.

Inner Coating

| | |
|---|---|
| Acryloid A 21-(Rohm & Haas) | 25% |
| Uvitex OB-(Ciba-Geigy Corp.) | 11% based on solids |
| Tinuvin 328-(Ciba-Geigy Corp.) | 8% based on solids |
| Acetylacetone | 8% based on total weight |
| Diluent toluene or xylene | depending upon method |
| | of application. |

### Outer Coating

A second coating is used to achieve a 3-4 micron film thickness It comprises: GR 653 polysiloxane coating—25% solids

| | |
|---|---|
| (Techneglas) | 97.5 parts |
| Tinuvin 328-(Ciba-Geigy Corp.) | 1.5 parts |
| Toluene | 1 part |

### EXAMPLE 2

Inside Layer-Acrylic

| | |
|---|---|
| Desmodur N-75: Bayer | 36% of urethane solids |
| Desmophen 670A-80: Bayer | 64% of urethane solids |
| Catalyst, dibutyltindilaurate | 0.1% based on urethane solids |
| UV inhibitor, Tinuvin 328- | 8% based on urethane solids |
| (Ciba-Geigy) | |
| Fluorescent, Tinuvin OB- | 11% based on urethane solids |
| (Ciba-Geigy) | |
| Surfactant, Flurad 430-(3M) | 0.1% based on urethane solids |
| Diluent, Toluene | To make 100% |

The best order for mixing is to determine the amount of toluene that will be the diluent and stir in the Tinuvin OB until it completely dissolves. Add the uv inhibitor and stir until completely dissolved. Add the Desmophen 670-80A and stir until completely dissolved. Add the Desmodur N-75 and stir until completely dissolved. Add the dibutyltindilaurate and stir. Add the catalyst and stir gently, until it is completely dissolved. The solids level of this coating can be adjusted to the processing technique and conditions to achieve approximately 15 microns film thickness. The lower the film thickness, the higher the required level of Tinuvin 328 and Tinuvin OB. The ratio between uv inhibitor and fluorescent material is dependent on the uv absorption of the inhibitor and the wavelength shift of the fluorescent material. The goal is to make the uv cut-off up to 400 nm and then have maximum light transmision for the visible spectrum.

Outer Layer-Acrylic

| | |
|---|---|
| Acryloid A-21-(Rohm & Haas) | recived at 30% solids, diluted |
| | to 25% solids with toluene |
| Flurad 430 (3M) | 0.1% based on total coating solids |
| Tinuvin 328-(Ciba Geigy) | 8% based on A-21 solids |
| Tinuvin OB-(Ciba Geigy) | 11%, based on A-21 solids |
| Acetylacetone | 8% of total weight |

### EXAMPLE 3

Polysiloxane Outer Layer

| | |
|---|---|
| SHC 4000 (General Electric) | 98.4% |
| Tinuvin-328 (Ciba-Geigy) | 1.5% |
| Triethanolamine (optical brightener) | .01% |

Toluene or Xylene solvent to achieve desired film thickness.

Acrylic Inner Layer

| | |
|---|---|
| Joncryl 537-(Johnson's Wax) | Acqueous acrylic dispersion |
| Uvinul D40-(BASF-Wyandotte) | 8% based on resin solids |
| Flurad 430-(3M) | 0.1% based on resin solids |
| Triethanolamine-( | 0.1% based on resin solids |
| QBA Quencher- | 0.1% based on resin solids |
| (Kalamazoo Chemical Corp.) | |

The outer coatings provide desired physical properties and they provide quenching of the optical brightener at the surface of the inside coating. This quenching is accomplished by uv transmission reduction by the outer coating and/or by adding a higher pH material, such as minor amounts of tetramethylamino-hydroxine to the outer coating which quenches the optical brightener.

Some typical applications are store front display windows to protect the items on display from ultraviolet damage, protection of inkjet prints which are very susceptible to ultraviolet degradation, plastic sheeting which degrades and turns yellow in outdoor applications, works of art which are subject to man-made ultrviolet radiation, and, in general, any item that is damaged by ultraviolet radiation. In order to achieve weatherability of inkjet prints which may be used for signs, posters, billboards, etc., it is often necessary to laminate them with films that provide protection against ultraviolet radiation.

In another embodiment, a thin layer of polyester film is coated on one surface with the blocking layer and the second coating is applied to the opposite surface. The film is provided with a suitable laminating adhesive, such as heat-activated vinyl, EVA, and similar adhesives. The film may be applied to an inkjet print on the printed side. This embodiment of the coating systems forms a thin flexible transparent tear resistant laminate which blocks out ultraviolet to less than one percent transmission at 400 nm and to less than 0.1% transmission below 400 nm down to 280 nm. A polysiloxane coating also provides scratch resistance, as well as chemical resistance.

By providing a two-layer system, rather than a single layer system, it is possible to have the inner layer absorb the bulk of received ultraviolet radiation, and reflect radiation above 375 nm as blue light, so that the coating is seen as clear rather than as a yellow tint. Most conveniently, both layers are applied using known spraying techniques in serial fashion, which lends itself to the application of both layers upon a thin polyester film, and the like. Other methods are possible, including dipping, flow-coating, curtain coating or by any other liquid application method.

I wish it to be understood that I do not consider the invention to be limited to the precise details and examples described hereinabove, for obvious modifications will occur to those skilled in the art to which the invention pertains.

I claim:

1. An ultraviolet radiation absorbing coating system comprising a first synthetic resinous layer having an ultraviolet radiation absorber with an ultraviolet cuttoff lower than about 385 nanometers, and a fluorescent material which reflects ultraviolet radiation of wavelength above 385 nanometers; and a second layer overlying said first layer and having an ultraviolet radiation absorbent material which blocks at least some ultraviolet radiation affecting the fluorescent material.

2. A coating system in accordance with claim 1, in which said second layer is comprised of a polysiloxane material.

3. A coating system in accordance with claim 1, in which said first and second layers are applied to opposite surfaces of a polyester film.

4. A system in accordance with claim 1, in which said first and second layers are applied to oppositely disposed surfaces of a synthetic resinous film.

5. A system in accordance with claim 4, in which said film includes an adhesive for application to a printed surface of a protected substrate.

6. An ultraviolet absorbing coating system in accordance with claim 1, including first and second inner and outer coatings of the following formulation. Parts are by weight of solids.
Inner Coating

| | |
|---|---|
| Acryloid A 21-(Rohm & Haas) | 25% (solids) |
| Uvitex OB-(Ciba-Geigy Corp.) | 11% based on solids |
| Tinuvin 328-(Ciba-Geigy Corp.) | 8% based on solids |
| Acetylacetone | 8% based on total weight |
| Diluent toluene or xylene | depending upon method |
| | of application. |

Outer Coating

| | |
|---|---|
| GR 653 polysiloxane coating- | 97.5 parts |
| (Techneglas) | |
| Tinuvin 328-(Ciba Geigy Corp.) | 1.5% based on GR653 solids |
| Toluene- | 1% based on total weight |

7. An ultraviolet absorbing coating system in accordance with claim 1, including first and second inner and outer coatings of the following formulation:
Inner Coating

| | |
|---|---|
| Desmodur N-75: Bayer | 36% of urethane solids |
| Desmophen 670A-80: Bayer | 64% of urethane solids |
| Catalyst, dibutyltindilaurate | 0.1% based on urethane solids |
| Tinuvin 328-(Ciba Geigy) | 8% based on urethane solids |
| Tinuvin OB-(Ciba Geigy) | 11% based on urethane solids |
| Flurad 430-(3M) | 0.1% based on urethane solids |
| Diluent, Toluene | To make 100% |

Outer Layer-Acrylic

| | |
|---|---|
| Acryloid A-21-(Rohm & Haas) | received at 30% solids, diluted |
| | to 25% solids with toluene |
| Flurad 430 (3M) | 0.1% based on total coating |
| Tinuvin 328-(Ciba Geigy) | 8% based on A-21 solids |
| Tinuvin OB-(Ciba Geigy) | 11%, based on A-21 solids |
| Acetylacetone | 8% of total weight |

8. An ultraviolet absorbing coating system in accordance with claim 1, said first and second coatings having the following formulation: Percantages based on resin solids.
Polysiloxane Outer Layer

| | |
|---|---|
| SHC 4000 (General Electric) | 98.2% |
| Tinuvin-328 (Ciba-Geigy) | 1.5% |
| Triethanolamine | 0.1% |

Toluene for appropriate coating thickness.
Acrylic Inner Coating

| | |
|---|---|
| Joncryl 537 - (Johnson's Wax) | Acqueous acrylic dispersion 98.2% |
| Uvinul D40 - (BASF-Wyandotte) | 1.5% based on resin solids |
| Flurad 430 - (3M) | 0.1% based on resin solids |
| Triethanolamine | 0.1% based on resin solids |
| OBA Quencher - | 0.1% based on resin solids |
| (Kalamazoo Chemical Corp.) | |
